(19) United States
(12) Patent Application Publication
(10) Pub. No.: US 2026/0142867 A1
(43) Pub. Date: May 21, 2026

(54) ANOMALY DETECTION SYSTEM AND METHODS

(71) Applicant: TWILIO INC., San Francisco, CA (US)

(72) Inventors: Eyad ISA, New York, NY (US); Martin Fernandez, Cumming, GA (US); Charlie HELIN, Murrieta, CA (US); Sherry CHENG, Woodside, NY (US)

(21) Appl. No.: 18/950,963

(22) Filed: Nov. 18, 2024

(51) Int. Cl. H04L 41/0604; H04L 41/16; H04L 41/22

(52) U.S. Cl. CPC H04L 41/0627; H04L 41/16; H04L 41/22

(57) ABSTRACT

A computing device can receive operation data associated with the normal operation of one or more containers for operating services. The computing device can receive incident data comprising a plurality of incidents impacting the services associated with the one or more containers. The computing device can train a machine learning algorithm to be predictive of when an incident has occurred based on the operation data and the incident data. The computing device can apply the machine learning algorithm to metadata associated with the one or more containers to generate at least one score. The computing device can determine if the score exceeds a predefined threshold, and in response to the at least one score exceeding a predefined threshold, determine a new incident has occurred or is impacting a service.

### TECHNICAL FIELD

The present systems and processes relate to detecting anomalies for containers in a microservice architecture.

### BACKGROUND

Cloud-based services occasionally experience outages or downtime. An outage or downtime can be characterized by a cloud-based service becoming unavailable to customers or by limited and/or delayed functionality. Many cloud-base service providers have service level agreements (“SLAs”) with the customers who use the cloud-based services. The SLAs may require that the service provider remedy the outage with a defined period of time set by the SLA. If the service provider is unable to remedy the outage within the defined period of time, the service provider may be required to pay a fee to the customer due to the unavailability of the service during the outage. In some cases, the service provider may be unaware of an outage until a customer complains, which increases the time required to detect and remedy the outage, which in turn increases the possibility that the service provider must pay the fee required under the SLA. Further, extensive downtime and outages can degrade customer trust, which may prompt existing customers to terminate their use of the service or discourage new customers from using the service. Therefore, there is a long-felt but unresolved need for quickly detecting and remedying service outages.

### BRIEF SUMMARY OF THE DISCLOSURE

Briefly described, and according to one embodiment, aspects of the present disclosure generally relate to incidents (e.g., outage, downtime, limited and/or delayed functionality) experienced by cloud-based services. Many cloud-base services can operate as a microservice architecture. Each service in the microservice architecture can be provided by a container. For example, a microservice architecture can include hundreds or thousands of services and each service can be operated by a container. As will be understood, a container can include an isolated computing environment that can allow software applications to run in isolated user spaces in parallel. A container can be associated with multiple health metrics. Container health metrics can include, but are not limited to, CPU usage, memory usage, network traffic, read and write operations, error rate (e.g., errors per minute, errors per second), traffic saturation, and latency time and queue length.

An anomaly in the relevant health container metric can occur before or during an incident. An anomaly can include any statistically significant change in a container health metric. An anomaly can be indicative of a future or ongoing incident, but may not be the cause of the incident. For example, a container may experience an anomalous increase in CPU usage, which may precede an incident for the service provided by the container. As another example, a container may experience an anomalous increase in memory usage when an incident for the service provided by the container begins to manifest.

A machine learning algorithm can be trained to detect anomalies in the container health metrics. The machine learning algorithm can generate a score indicative of an anomaly and an incident. In some embodiments, the machine learning algorithm can generate a recommendation for a remedial action to remedy the incident. The machine learning algorithm can be trained using container health metrics from previous incidents and can be re-trained using new container health metrics from new incidents.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A illustrates a cloud-based system according to various embodiments of the present disclosure.

FIG. 1B illustrates an anomaly detection system according to various embodiments of the present disclosure.

FIG. 2 illustrates an exemplary networked environment for the disclosed system according to various embodiments of the present disclosure.

FIG. 3 illustrates an anomaly detection process for the disclosed system according to various embodiments of the present disclosure.

FIG. 4 illustrates a data lake process for the disclosed system according to various embodiments of the present disclosure.

FIG. 5 illustrates a machine learning algorithm training process for the disclosed system according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to detecting incidents (e.g., outage, downtime, limited and/or delayed functionality) experienced by cloud-based services. The anomaly detection system can receive operation data and incident data for the containers providing functionality to the cloud-based services. Both the operation data and the incident data can include container health metrics, but the operation data can be associated with normal or expected container operation and the incident data can be associated with historic incidents impacting the services. The incident data can include any data related to the historic incidents, including but not limited to, the cause of the incident, the type of incident, the severity of the incident, the impact of the incident (e.g., the impact on the service, the amount of time that the service was impacted), and any remedial actions performed to resolve the incident. The operation data and the incident data can be stored in a data lake. The data lake can receive and store real-time container health metric data.

A machine learning algorithm can be trained to detect anomalies in the real-time container health metrics and incidents impacting the services. As will be understood, an anomaly can include any statistically significant change in a container health metric. An anomaly can be a symptom or a cause of an incident impacting the cloud-based service. For example, the machine learning algorithm can be trained and validated using the data in the data lake. For example, the data lake can be segmented into a training set and a validation set. The machine learning algorithm can be trained to generate a score indicating of an anomaly in the real-time container health metrics and incidents impacting the services. Once trained and validated, the machine learning algorithm can be applied to the real-time health metrics to generate a score. The score can be compared to a score threshold, and if the score exceeds the score threshold, the anomaly detection system can identify an anomaly in the health metrics or determine the likelihood of an incident impacting the services.

In response to identifying the anomaly or determining the likelihood of an incident impacting the services, the anomaly detection system can generate a dashboard including any data related to the anomaly and/or incident. For example, the dashboard can include graphs illustrating the changes to the container metrics over time. The anomaly detection system can generate a recommendation for a remedial action to remedy the incident and transmit a notification to the service provider.

### Exemplary Embodiments

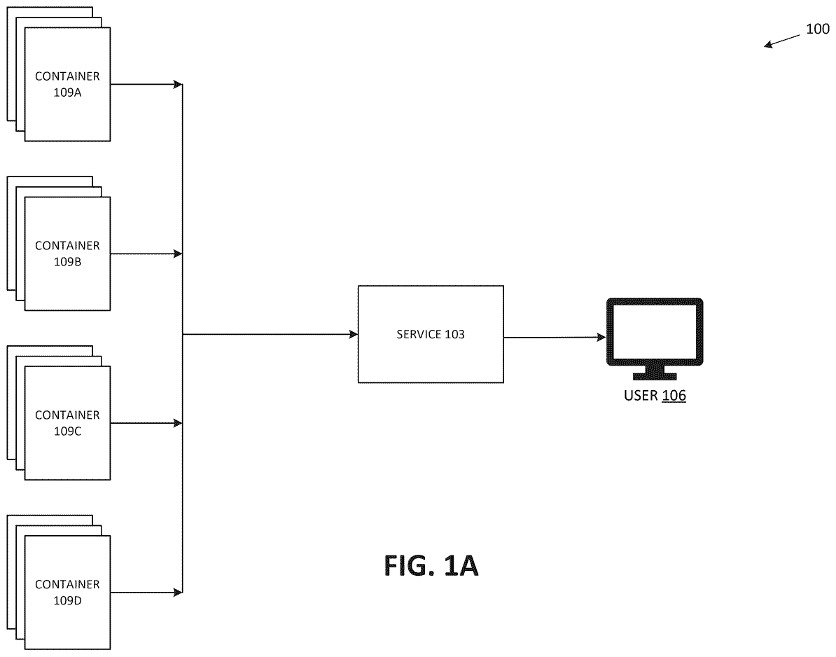

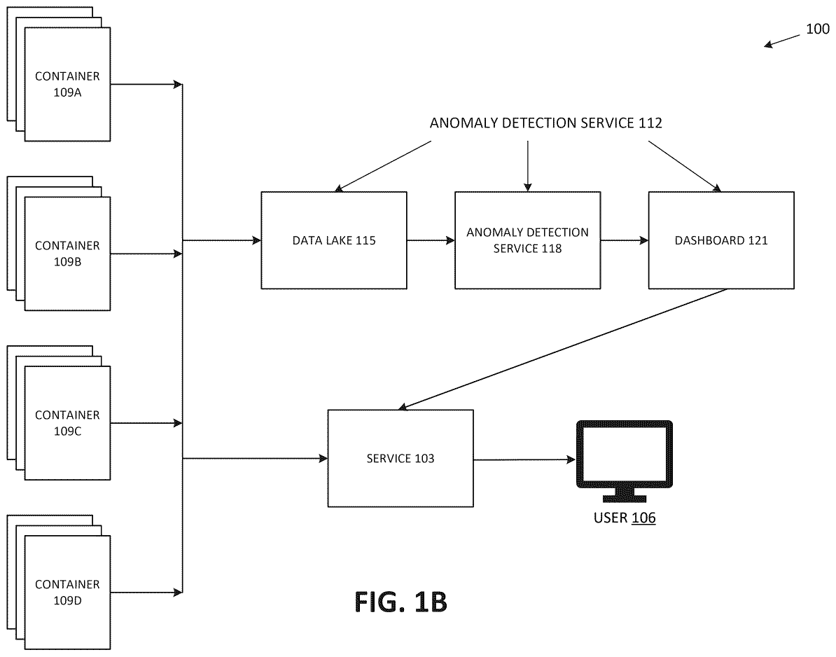

Referring now to the figures, for the purposes of example and explanation of the fundamental processes and components of the disclosed systems and processes, reference is made to FIG. 1A, which illustrates the exemplary service system 100 (“system 100”). The system 100 can include the service 103. The service 103 can be a cloud-based service for use by the user 106. As an example, the service 103 can include a messaging service. For example, the user 106 can use the service 103 to message with their end-users. As another example, the service 103 can include a voice service, an identity service, a customer support service, or any cloud-based service with users.

The service 103 can be operated by the containers 109A-109D. As will be understood, the containers 109A-109D are merely exemplary and the service 103 may be operated by a microservice architecture with any number of containers operating microservices. Each of the containers 109A-109D can be associated with health metrics. Container health metrics can include, but are not limited to, CPU usage, memory usage, network traffic, read and write operations, error rate (e.g., errors per minute, errors per second), traffic saturation, and latency time and queue length.

One of the containers 109A-109D can experience an anomalous change in a container health metric. For example, the container 109A can experience an increase in CPU usage, memory usage, and/or network traffic. In this example, the increase in CPU usage, memory usage, and/or network traffic can be characterized as an anomaly or an anomalous change in the container health metric. The anomaly can occur before or during an incident with the service 103. As will be understood, the anomaly may be a symptom or cause of the incident. The incident can cause the service 103 to become unavailable to the user 106 or limit or delay the functionality of the service 103.

Referring now to FIG. 1B, shown is the exemplary system 100 incorporating the anomaly detection service 112. The anomaly detection service 112 can include the data lake 115, the anomaly detection service 118, and the dashboard 121. The health metrics from the containers 109A-109D can be provided to the data lake 115. The data lake 115 can receive both the historical health metrics and the real-time health metrics from the containers 109A-109D. The data lake 115 can include historical incident data associated with the containers 109A-109D. The historical incident data can include any metadata related to the containers 109A-109D and any data related to previous incidents (e.g., the cause of the incident, the length of the incident, the severity of the incident, the outcome of the incident, the remedy for the incident). In some embodiments, the data included in the data lake 115 (e.g., the historical health metrics, the real-time health metrics, metadata, incident data) may not include the service 103 provided by the containers 109A-109D. For example, the incident data may include that the service 103 experienced an outage, but may not include or indicate the nature or functionality of the service 103 (e.g., the incident data may not include the service 103 is a messaging service, a voice service, etc.).

The anomaly detection service 118 can include a machine learning algorithm. The machine learning algorithm can include any type of machine learning algorithm capable of generating a score indicative of an anomaly. The machine learning algorithm can be trained using the data in the data lake 115. Once trained, the machine learning algorithm can be applied to the real-time health metrics associated with the containers 109A-109D in the data lake 115. The machine learning algorithm can be applied to the real-time health metric to generate a score indicative of an anomaly. The score generated by the machine learning algorithm can be used to determine if the service 103 is currently experiencing an incident or if an incident is about to begin that can impact the service 103. The score can be used to determine the type of incident and the severity of the incident. If the score indicates that the service 103 is experiencing an incident or is about to experience an incident, the anomaly detection service 118 can recommend a remedial action for remedying the incident.

If the score is indicative of an anomaly, the data generated by the anomaly detection service 118 can be displayed on the dashboard 121. For example, the dashboard 121 can display the score generated by the anomaly detection service 118 and any data related to the incident (e.g., if the incident is ongoing, the severity of the incident, the service 103 impacted, the type of incident) and the recommended remedial action. The dashboard 121 can display the health metrics as a graph (e.g., display the health metrics over time include the anomaly). Generating the dashboard 121 can include notifying the service provider for the service 103 that an anomaly has been detected and indicates that an incident is ongoing or about to begin impacting the service 103. The remedial action can be performed to remedy the incident impacting the service 103.

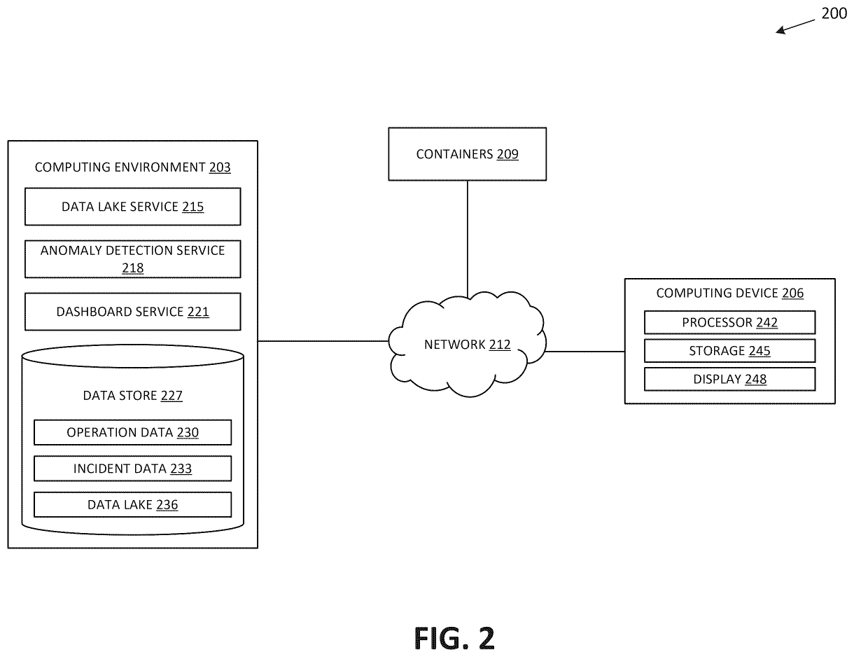

Referring now to FIG. 2, shown is an exemplary networked environment 200 for the anomaly detection system according to various embodiments of the present disclosure. As will be understood and appreciated, the exemplary networked environment 200 shown in FIG. 2 represents merely one approach or embodiment of the present system, and other aspects are used according to various embodiments of the present system. Exemplary networked environment 200 can include, but is not limited to, a computing environment 203 connected to one or more computing devices 206 and the containers 209 over a network 212.

The elements of the computing environment 203 can be provided via one or more computing devices that may be arranged, for example, in one or more server banks or computer banks or other arrangements. Such computing devices can be located in a single installation or may be distributed among many different geographical locations. For example, the computing environment 203 can include one or more computing devices that together may include a hosted computing resource, a grid computing resource, or any other distributed computing arrangement. In some cases, the computing environment 203 can correspond to an elastic computing resource where the allotted capacity of processing, network, storage, or other computing-related resources may vary over time. Regardless, the computing environment 203 can include one or more processors and memory having instructions stored thereon that, when executed by the one or more processors, cause the computing environment 203 to perform one, some, or all of the actions, methods, steps, or functionalities provided herein.

The computing environment 203 can include a data lake service 215, an anomaly detection service 218, a dashboard service 221, and the data store 227. The data lake service 215, the anomaly detection service 218, and the dashboard service 221 can correspond to one or more software executables that can be executed by the computing environment 203 to perform the functionality described herein. While the data lake service 215, the anomaly detection service 218, and the dashboard service 221 are described as different services, it can be appreciated that the functionality of these services can be implemented in one or more different services executed in the computing environment 203. Various data can be stored in the data store 227, including but not limited to, the operation data 230, the incident data 233, and the data lake 236.

The data lake service 215 can receive any data related to the operation of the containers 209. For example, the data lake service 215 can receive and store the operation data 230 and the incident data 233 associated with the containers 209. The operation data 230 can include any data related to the operation of the containers 209 when an incident is not impacting the service provided by the containers 209. As will be understood, the operation data 230 can include any data related to the normal or expected operation of the containers 209. The operation data 230 may not include any data related to historic or new incidents detected by the anomaly detection system. The operation data 230 can include any container metadata and container health metrics (e.g., CPU usage, memory usage, network traffic). The incident data 233 can include any data related incidents impacting the services provided by the containers 209. The incidents can include historic (e.g., previous incidents) and new incidents detected by the anomaly detection system. The incident data 233 can include any container metadata and container health metrics (e.g., CPU usage, memory usage, network traffic) associated with an incident. The incident data 233 can include any data related to incidents, including but not limited to the type of incident, the severity of the incident, the amount of time impacted, and the remedial action performed. Both the operation data 230 and the incident data 233 may not include the functionality of the services provided by the containers 209 (e.g., if a container provides a messaging service, the data may not include that the container is provided a messaging service).

The data lake service 236 can perform any extract, transform, and load techniques or feature engineering techniques to the operation data 230 and the incident data 233. The data lake service 236 can store the operation data 230 and the incident data 233 as the data lake 236. As will be understood, the data lake 236 can include a centralized repository for storing the operation data 230 and the incident data 233 in any format. The data lake 236 can include the real-time health metrics from the containers 209. The data lake 236 can be used for training and validating the machine learning algorithm provided by the anomaly detection service 218. The trained machine learning algorithm can be applied to the real-time container health metrics in the data lake 236 to detect anomalies in the health metrics and determine new incidents impacting the services provided by the containers 209.

The anomaly detection service 218 can detect anomalies in the health metrics and determine new incidents impacting the services provided by the containers 209 by applying a machine learning algorithm to the data in the data lake 236. As an example, the machine learning algorithm can include any machine learning algorithm capable of anomaly detection and generating scores. The machine learning algorithm or model can be any machine learning algorithm or model or combination thereof, including but not limited to nearest neighbor, support vector machines, gradient boosting, neural networks, logistic regression, linear regression, decision trees, random forest, Naive Bayes, k-means clustering, time series regression, pointwise prediction, stepwise regression, Gaussian models, hidden Markov models, ensemble learning models, means-shift clustering, exponential moving average, anomaly detection models (e.g., memory-based anomaly detection, sketch-based anomaly detection, variational autoencoders, long short-term memory, recurrent neural networks, exponential smoothing, time-series) and Bayesian models. The anomaly detection service 218 can train and validate the machine learning algorithm using the data in the data lake 236.

The anomaly detection service 218 can apply the trained machine learning algorithm to the real-time container health metrics in the data lake 236. By applying the trained machine learning algorithm to the real-time container health metrics, the anomaly detection service 218 can generate scores. The scores can be indicative of anomalies in the real-time container health metrics and/or indicative of new incidents impacting the services provided by the containers 209 (e.g., an incident can include one or more containers experiencing an outage, downtime, limited and/or delayed functionality). For example, an incident can impact a service provided by the containers 209 when an incident begins, occurs, or is ongoing. As another example, a new incident can impact a service provided by the containers 209 once the new incident begins occuring. The trained machine learning algorithm can be applied to the data lake 236 to determine container baselines. The baseline can represent normal or expected container health metrics for the containers 209. The baseline can represent a standard value for the container health metrics when an incident is not impacting the services provided by the containers 209. The baseline can include a standard deviation. As another example, the trained machine learning algorithm can be applied to the data lake 236 to generate score thresholds. The scores generated by the machine learning algorithm can be compared to the scores thresholds to determine if an anomaly is present in the health metrics or to determine the likelihood of an incident impacting the services provided by the containers 209. As another example, the scores generated by the machine learning algorithm can be compared to the scores thresholds to determine the severity or the type of incident impacting the services provided by the containers 209.

If the anomaly detection service 218 determines that an incident is impacting the services, the anomaly detection service 218 can recommend a remedial action. For example, if the anomaly or the detected incident is similar to a historic incident in the incident data 233, the anomaly detection service 218 can recommend a remedial action based on the remedial action that remedied the historic incident. As another example, the anomaly detection service 218 can determine a remedial action based on the real-time container health metrics.

The dashboard service 221 can generate a dashboard including all of the data related to the detected anomaly and incident. The dashboard can include the generated scores, the incident likelihood, the incident type, the incident severity, and the container health metrics. For example, the container health metrics can be displayed in a graph showing the change over a period of time. The dashboard can include the recommended remedial action. Any of the data related to the new incident (e.g., the incident determined at the step 312) can be saved as the incident data 233. The dashboard service 221 can transmit a notification to the service provider such that the incident can be remedied as quickly as possible.

According to various embodiments, the computing device 206 can include any device capable of accessing network 212 including, but not limited to, a computer, smartphone, tablets, or other device. The computing device 206 can include a processor 242 and storage 245. The computing device 206 can include a display 248 on which various user interfaces can be rendered to allow users to configure, monitor, control, and command various functions of networked environment 200. In various embodiments, computing device 206 can include multiple computing devices. Regardless, the computing device 206 can include one or more processors and memory having instructions stored thereon that, when executed by the one or more processors, cause the computing device 206 to perform one, some, or all of the actions, methods, steps, or functionalities provided herein.

The containers 209 can include any container for operating a cloud-based service. As will be understood, each container 209 can include an isolated computing environment that can allow software applications to run in isolated user spaces in parallel. Each container 209 can be associated any health metrics, including but not limited to, CPU usage, memory usage, network traffic, read and write operations, error rate (e.g., errors per minute, errors per second), traffic saturation, and latency time and queue length.

The network 212 includes, for example, the Internet, intranets, extranets, wide area networks (WANs), local area networks (LANs), wired networks, wireless networks, or other suitable networks, etc., or any combination of two or more such networks.

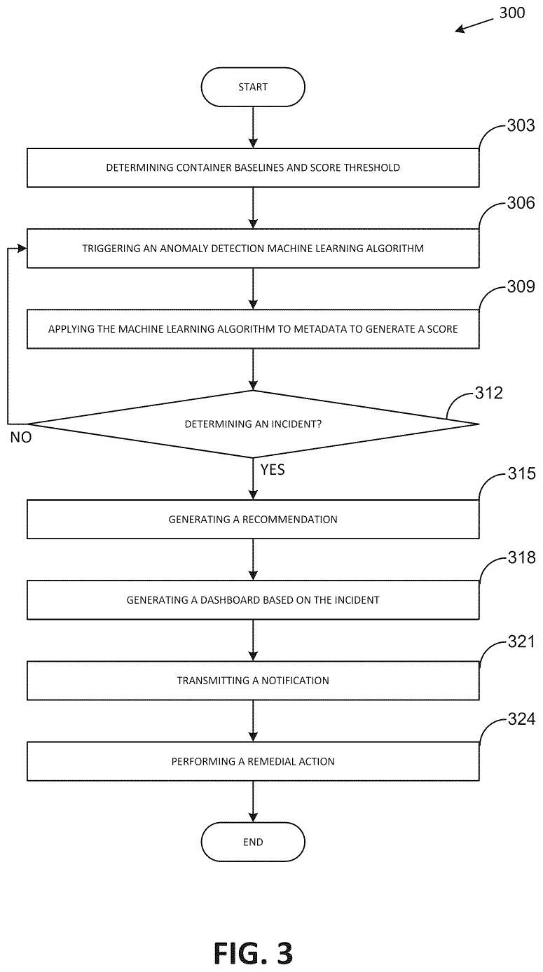

Referring now to FIG. 3, shown is an exemplary, anomaly detection process 300 according to various embodiments of the present disclosure. As will be understood by one having ordinary skill in the art, the steps and processes shown in FIGS. 3-5 may operate concurrently and continuously, are generally asynchronous and independent, can be performed in part or in whole by a combination of one or more of the computing environment 203, the computing device 206, and the containers 209 and are not necessarily performed in the order shown and various steps can be executed linearly or in parallel. Process 300 can be performed entirely, partially, or in coordination with the data lake service 215, the anomaly detection service 218, and the dashboard service 221.

At step 303, the process 300 can determine container baselines and score thresholds. The anomaly detection service 218 can determine the container baselines and score thresholds. The container baselines can include a baseline metric for the container health metrics. The real-time health metrics can be compared to the container baselines to determine if an anomalous change in the health metrics occurs. For example, the anomaly detection service 218 can apply a trained machine learning algorithm to the operation data 230 to determine a baseline for the container health metrics. As an example, the anomaly detection service 218 can determine a baseline for any container health metric, including but not limited to, CPU usage, memory usage, and/or network traffic. The container baseline can include a standard deviation. For example, if a change in a health metric is within the standard deviation of the baseline, the change may not be anomalous.

The score thresholds can include a threshold for determining if an anomaly in the health metrics is indicative of an incident (e.g., an incident can include one or more containers experiencing an outage, downtime, limited and/or delayed functionality). As an example, the score threshold can indicate that an incident has begun occurring or is currently ongoing and may be limiting the services or functionality provided by the container. In some embodiments, the score threshold can indicate if a change in a container health metric is anomalous. Multiple score thresholds can be determined. For example, the score thresholds can include a threshold for determining if a change in a container health metric is anomalous, a threshold for determining if an anomaly is indicative of an incident impacting a container, a threshold for determining the severity of the incident, and a threshold for determining the type of incident. The anomaly detection service 218 can apply a trained machine learning algorithm to the data lake 236 to determine the score thresholds. In some embodiments, the score thresholds can be determined via input or based on a policy or rule.

At step 306, the process 300 can include triggering an anomaly detection machine learning algorithm. The anomaly detection service 218 can trigger the anomaly detection machine learning algorithm. For example, the anomaly detection machine learning algorithm can be triggered in response to the anomaly detection service 218 receiving a request for the score. As another example, the anomaly detection machine learning algorithm can be triggered in response to a change in the container health metric. If the container health metric increases or decreases more than the standard deviation or falls below or exceeds the container baseline, the anomaly detection machine learning algorithm can be triggered. As will be understood, if the anomaly detection machine learning algorithm is triggered, the process 300 can proceed to the step 309.

In some embodiments, the step 306 can be optional. For example, the anomaly detection machine learning algorithm can be continually applied to the real-time container health metrics or can be applied repeatedly after a predefined interval of time (e.g., every minute, every 5 minutes, every 10 minutes, every 30 minutes, every 1 hour).

At step 309, the process 300 can include applying the machine learning algorithm to the container metadata to generate at least one score. The anomaly detection service 218 can apply the machine learning algorithm to the container metadata to generate at least one score. The score can be used to determine if a change in a health metric is anomalous and/or if a service is experiencing an incident. The container metadata can include any metadata from the containers 209. For example, the container metadata can include the real-time container health metrics (e.g., current CPU usage, current memory usage, current network traffic). The container metadata can include any data stored as the operation data 230 or any data stored in the data lake 236. In some embodiments, the container metadata can be received from the containers 209 and stored in the data lake 236 in real time. In some embodiments, the machine learning algorithm can generate multiple scores. For example, the machine learning algorithm can generate a score indicating if a change in a container health metric is anomalous, a score for determining if an incident is impacting a service, a score for the severity of the incident, and a score for the type of incident. As an example, the machine learning algorithm can generate a score indicating a likelihood or probability that a service is experiencing an incident.

At step 312, the process 300 can include determining if an incident is impacting a service (e.g., an incident can include one or more containers experiencing an outage, downtime, limited and/or delayed functionality). The anomaly detection service 218 can determine if an incident is impacting a service. For example, the anomaly detection service 218 can determine that an incident has begun or is occurring and is impacting the service provided (e.g., resulting in an outage, downtime, limited and/or delayed functionality or service). The anomaly detection service 218 can determine if an incident is impacting a service by comparing the generated scores to the score thresholds. For example, if the score exceeds the threshold for determining an anomaly, the anomaly detection service 218 can determine an anomaly is present in the health metrics and a likelihood that an incident is impacting a service or is about to impact a service.

As another example, if the score exceeds the threshold for determining an incident, the anomaly detection service 218 can determine a likelihood that an incident is impacting a service or is about to impact a service. As another example, if the score exceeds a threshold for an incident type or incident severity, the anomaly detection service 218 can determine an incident type and/or an incident severity. If the generated score exceeds a score threshold, the process 300 can proceed to the step 315. If the generated score does not exceed the score threshold, the process 300 can return to the step 306. If the step 306 is optional, the process 300 can return to the step 309.

At step 315, the process 300 can include generating a recommendation. The anomaly detection service 218 can generate a recommendation. The anomaly detection service 218 can generate a recommendation based on any container metadata or the incident data 233. For example, if the anomaly or the detected incident is similar to a historic incident in the incident data 233, the anomaly detection service 218 can recommend a remedial action based on the remedial action that remedied the historic incident. As another example, the anomaly detection service 218 can determine a remedial action based on the real-time container health metrics. For example, the remedial action can include backing up the container or spinning up a new host. As another example, the remedial action can include redirecting traffic to and/or from the container. As another example, the remedial action can include rolling back the image used on the container.

At step 318, the process 300 can include generating a dashboard based on the incident. The dashboard service 221 can generate a dashboard based on the incident. The dashboard can include the generated scores, the incident likelihood, the incident type, the incident severity, and the container health metrics. For example, the container health metrics can be displayed in a graph showing the change over a period of time. The dashboard can include the recommended remedial action. Any of the data related to the new incident (e.g., the incident determined at the step 312) can be saved as the incident data 233.

At step 321, the process 300 can include transmitting a notification. The dashboard service 221 can transmit a notification to the service provider for the impacted service. The notification can include any of the data included in the dashboard and a link to access the dashboard. The notification can be transmitted as a message in any channel (e.g., SMS message, native application alert, message on a messaging platform).

At step 324, the process 300 can include performing the remedial action. The anomaly detection service 218 can perform the remedial action. For example, the remedial action can be performed in response to an input accepting the remedial action. As another example, the remedial action can be performed in response to a policy or rule to perform the remedial action if an incident is detected.

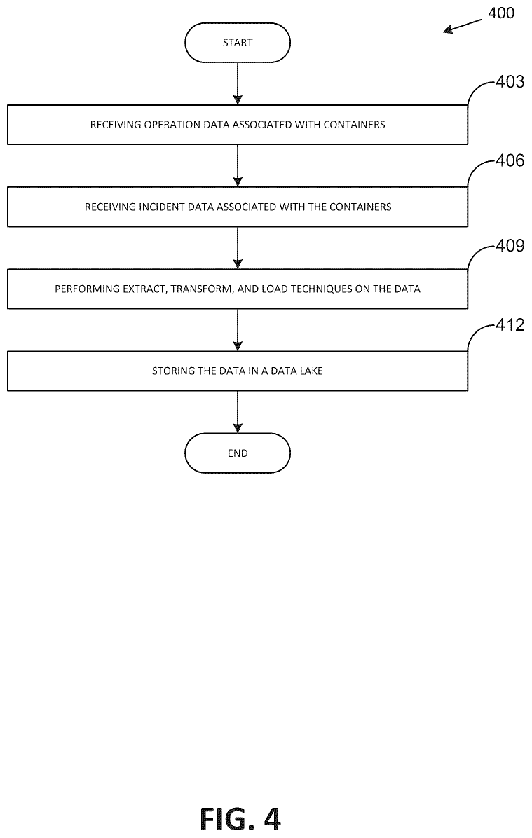

Referring now to FIG. 4, shown is an exemplary data lake process 400 according to various embodiments of the present disclosure. Process 400 can be performed entirely, partially, or in coordination with the data lake service 215. At step 403, the process 400 can include receiving operation data associated with the containers. The data lake service 215 can receive the operation data associated with the containers. The data lake service 215 can receive the operation data from the containers 209 and save the data as the operation data 230 in the data store 227. The operation data can include any metadata associated with the containers and historic health metrics. The operation data may not include any container health metrics associated with previous or historic incidents. As will be understood, the operation data can be representative of the containers when operating as expected. The operation data can be used to determine the container baselines. The operation data may not specify the functionality provided by the containers 209. Step 403 can include receiving the real-time operation data, including the health metric data, from the containers 209.

At step 406, the process 400 can include receiving incident data associated with the containers. The data lake service 215 can receive the incident data associated with the containers. The data lake service 215 can receive the incident data from the containers 209 and save the data as the incident data 233 in the data store 227. The incident data can include any metadata associated with the containers and historic incidents. For example, the incident data can include the historic health metrics associated with historic incidents. As another example, the incident data can include the incident type, the incident severity, and any remedial actions taken to remedy the historic incidents. Step 406 can include receiving incident data from new incidents detected by the machine learning algorithm in process 300.

At step 409, the process 400 can include performing extract, transform, and load (“ETL”) techniques on the operation data and the incident data. The data lake service 215 can perform ETL techniques on the operation data and the incident data. For example, the data lake service 215 can normalize the data, aggregate relevant data, translate coded values, and any other ETL techniques necessary to store the data in the data lake 236. As another example, the data lake service 215 can perform feature engineering to create a training set for the machine learning algorithm. As another example, the data lake service 215 can handle missing values (e.g., encoding missing values, substituting the mean, median, or a random value, dropping missing values, labeling missing values).

At step 412, the process 400 can store the operation data and the incident data in the data lake. The data lake service 215 can store the operation data and the incident data in the data lake 236. Any data in the data lake service 215 can be used for training the machine learning algorithms. Further, the machine learning algorithm can be applied to any of the data in the data lake 236.

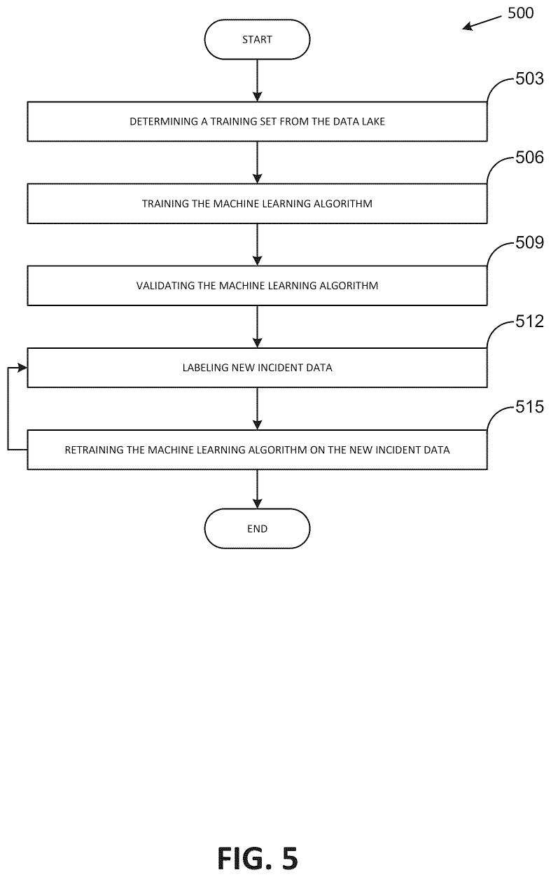

Referring now to FIG. 5, shown is an exemplary machine learning algorithm training process 500 according to various embodiments of the present disclosure. Process 500 can be performed entirely, partially, or in coordination with the anomaly detection service 218. At step 503, the process 500 can include determining a training set from the data lake. The anomaly detection service 218 can determine a training set from the data lake 236. For example, a portion or percent of the data in the data lake 236 can be segmented to training purposes. The remaining portion can be segmented for validation and/or testing purposes. Determining the training set can include performing feature selection to select features and/or hyperparameters for training the machine learning algorithm.

At step 506, the process 500 can include training the machine learning algorithm. The anomaly detection service 218 can train the machine learning algorithm. The machine learning algorithm can be trained using the training set determined at the step 503. The machine learning algorithm can be trained to generate a score indicative of an anomaly in the real-time health metrics. The machine learning algorithm can be trained to generate a score indicative of an incident impacting a service or the likelihood of an incident impacting a service.

At step 509, the process 500 can include validating the machine learning algorithm. The anomaly detection service 218 can validate the trained machine learning algorithm. As will be understood, the machine learning algorithm can be validated to determine the accuracy of the scores generated by the machine learning algorithm. The machine learning algorithm can be validated using the portion of the data in the data lake 236 that was segmented for validation purposes. As will be understood, the machine learning algorithm can be validating using data excluded from the training of the machine learning algorithm.

At step 512, the process 512 can include labeling new incident data. The anomaly detection service 218 can label the new incident data. As will be understood, any data related to incidents detected by process 300 can be saved as the incident data 233 and saved in the data lake 236. Labeling the new incident data can include adding data related to the severity of the incident, the length of time the service was impacted by the incident, the nature of the impact, the type of incident, and any remedial action taken to remedy the incident. Labeling the new incident data can include labeling anomalies detected by process 300 as incidents.

At step 515, the process 515 can include retraining the machine learning algorithm based on the new incidents. The anomaly detection service 218 can retrain the machine learning algorithm based on the new incidents. For example, the new incident data can be added to the training sets and validation sets for retraining and revalidating the machine learning algorithm. As will be understood, retraining the machine learning algorithm can improve the accuracy of the machine learning algorithm.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.

Claus 1. A method, comprising: receiving, via one of one or more computing devices, operation data associated with one or more containers; receiving, via one of the one or more computing devices, incident data comprising a plurality of incidents associated with the one or more containers; training, via one of the one or more computing devices, a machine learning algorithm to predict when an incident has occurred based on the operation data and the incident data; applying, via one of the one or more computing devices, the machine learning algorithm to metadata associated with the one or more containers to generate at least one score; and in response to the at least one score exceeding a predefined threshold, determining, via one of the one or more computing devices, an occurrence of a new incident.

Clause 2. The method of clause 1, further comprising: receiving, via one of the one or more computing devices, a request for the at least one score; and in response to receiving the request, generating, via one of the one or more computing devices, a dashboard comprising the at least one score.

Clause 3. The method of clause 1, further comprising retraining, via one of the one or more computing devices, the machine learning algorithm based on the new incident.

Clause 4. The method of clause 1, wherein the at least one score is determinative of a likelihood of the occurrence of the new incident and an incident type.

Clause 5. The method of clause 1, wherein the one or more containers comprises at least one of a messaging service, a voice service, an identity verification service, or a customer support service.

Clause 6. The method of clause 1, wherein the metadata comprises an increase in at least one of CPU usage or memory usage.

Clause 7. The method of clause 1, wherein the one or more containers is configured to provide a service and the service is excluded from the operation data.

Clause 8. A system, comprising: a memory device; and at least one computing device communicatively coupled to the memory device, the at least one computing device being configured to: receive operation data associated with one or more containers; receive incident data comprising a plurality of incidents associated with the one or more containers; train a machine learning algorithm to predict when an incident has occurred based on the operation data and the incident data; apply the machine learning algorithm to metadata associated with the one or more containers to generate at least one score; and in response to the at least one score exceeding a predefined threshold, determine an occurrence of a new incident.

Clause 9. The system of clause 8, wherein the at least one computing device is further configured to: receive a request for the at least one score; and in response to receiving the request, generate a dashboard comprising the at least one score.

Clause 10. The system of clause 8, wherein the at least one computing device is further configured to retrain the machine learning algorithm based on the new incident.

Clause 11. The system of clause 8, wherein the at least one score is determinative of a likelihood of the occurrence of the new incident and an incident type.

Clause 12. The system of clause 8, wherein the one or more containers comprises at least one of a messaging service, a voice service, an identity verification service, or a customer support service.

Clause 13. The system of clause 8, wherein the metadata comprises an increase in at least one of CPU usage or memory usage.

Clause 14. The system of clause 8, wherein the one or more containers is configured to provide a service and the service is excluded from the operation data.

Clause 15. A non-transitory computer-readable medium embodying a program that, when executed by at least one computing device, cause the at least one computing device to: receive operation data associated with one or more containers; receive incident data comprising a plurality of incidents associated with the one or more containers; train a machine learning algorithm to predict when an incident has occurred based on the operation data and the incident data; apply the machine learning algorithm to metadata associated with the one or more containers to generate at least one score; and in response to the at least one score exceeding a predefined threshold, determine an occurrence of a new incident.

Clause 16. The non-transitory computer-readable medium of clause 15, wherein the program further causes the at least one computing device to: receive a request for the at least one score; and in response to receiving the request, generate a dashboard comprising the at least one score.

Clause 17. The non-transitory computer-readable medium of clause 15, wherein the program further causes the at least one computing device to retrain the machine learning algorithm based on the new incident.

Clause 18. The non-transitory computer-readable medium of clause 15, wherein the at least one score is determinative of a likelihood of the occurrence of the new incident and an incident type.

Clause 19. The non-transitory computer-readable medium of clause 18, wherein the one or more containers comprises at least one of a messaging service, a voice service, an identity verification service, or a customer support service.

Clause 20. The non-transitory computer-readable medium of clause 15, wherein the metadata comprises an increase in at least one of CPU usage or memory usage.

These and other aspects, features, and benefits of the claims will become apparent from the detailed written description of the aforementioned aspects taken in conjunction with the accompanying drawings, although variations and modifications thereto may be affected without departing from the spirit and scope of the novel concepts of the disclosure.

What is claimed is:

1. A method, comprising:
receiving, via one of one or more computing devices, operation data associated with one or more containers;
receiving, via one of the one or more computing devices, incident data comprising a plurality of incidents associated with the one or more containers;
training, via one of the one or more computing devices, a machine learning algorithm to predict when an incident has occurred based on the operation data and the incident data;
applying, via one of the one or more computing devices, the machine learning algorithm to metadata associated with the one or more containers to generate at least one score; and
in response to the at least one score exceeding a predefined threshold, determining, via one of the one or more computing devices, an occurrence of a new incident.

2. The method of claim 1, further comprising:
receiving, via one of the one or more computing devices, a request for the at least one score; and
in response to receiving the request, generating, via one of the one or more computing devices, a dashboard comprising the at least one score.

3. The method of claim 1, further comprising retraining, via one of the one or more computing devices, the machine learning algorithm based on the new incident.

4. The method of claim 1, wherein the at least one score is determinative of a likelihood of the occurrence of the new incident and an incident type.

5. The method of claim 1, wherein the one or more containers comprises at least one of a messaging service, a voice service, an identity verification service, or a customer support service.

6. The method of claim 1, wherein the metadata comprises an increase in at least one of CPU usage or memory usage.

7. The method of claim 1, wherein the one or more containers is configured to provide a service and the service is excluded from the operation data.

8. A system, comprising:
a memory device; and
at least one computing device communicatively coupled to the memory device, the at least one computing device being configured to:
receive operation data associated with one or more containers;
receive incident data comprising a plurality of incidents associated with the one or more containers;
train a machine learning algorithm to predict when an incident has occurred based on the operation data and the incident data;
apply the machine learning algorithm to metadata associated with the one or more containers to generate at least one score; and
in response to the at least one score exceeding a predefined threshold, determine an occurrence of a new incident.

9. The system of claim 8, wherein the at least one computing device is further configured to:
receive a request for the at least one score; and
in response to receiving the request, generate a dashboard comprising the at least one score.

10. The system of claim 8, wherein the at least one computing device is further configured to retrain the machine learning algorithm based on the new incident.

11. The system of claim 8, wherein the at least one score is determinative of a likelihood of the occurrence of the new incident and an incident type.

12. The system of claim 8, wherein the one or more containers comprises at least one of a messaging service, a voice service, an identity verification service, or a customer support service.

13. The system of claim 8, wherein the metadata comprises an increase in at least one of CPU usage or memory usage.

14. The system of claim 8, wherein the one or more containers is configured to provide a service and the service is excluded from the operation data.

15. A non-transitory computer-readable medium embodying a program that, when executed by at least one computing device, cause the at least one computing device to:
receive operation data associated with one or more containers;
receive incident data comprising a plurality of incidents associated with the one or more containers;
train a machine learning algorithm to predict when an incident has occurred based on the operation data and the incident data;
apply the machine learning algorithm to metadata associated with the one or more containers to generate at least one score; and
in response to the at least one score exceeding a predefined threshold, determine an occurrence of a new incident.

16. The non-transitory computer-readable medium of claim 15, wherein the program further causes the at least one computing device to:
receive a request for the at least one score; and
in response to receiving the request, generate a dashboard comprising the at least one score.

17. The non-transitory computer-readable medium of claim 15, wherein the program further causes the at least one computing device to retrain the machine learning algorithm based on the new incident.

18. The non-transitory computer-readable medium of claim 15, wherein the at least one score is determinative of a likelihood of the occurrence of the new incident and an incident type.

19. The non-transitory computer-readable medium of claim 18, wherein the one or more containers comprises at least one of a messaging service, a voice service, an identity verification service, or a customer support service.

20. The non-transitory computer-readable medium of claim 15, wherein the metadata comprises an increase in at least one of CPU usage or memory usage.
